(19) United States
(12) Patent Application Publication
(10) Pub. No.: US 2014/0286257 A1
(43) Pub. Date: Sep. 25, 2014

(54) METHOD AND APPARATUS FOR PERFORMING CONTROL CHANNEL SCHEDULING IN ORTHOGONAL FREQUENCY DIVISION MULTIPLEXING ACCESS (OFDMA)-BASED WIRELESS MESH NETWORK

(71) Applicant: INTELLECTUAL DISCOVERY CO., LTD., Seoul (KR)

(72) Inventor: Suk Chan KIM, Busan (KR)

(73) Assignee: INTELLECTUAL DISCOVERY CO., LTD., Seoul (KR)

(21) Appl. No.: 14/224,781

(22) Filed: Mar. 25, 2014

(30) Foreign Application Priority Data
Mar. 25, 2013 (KR) 10-2013-0031558

(51) Int. Cl. H04W 72/12; H04L 5/00; H04W 72/14

(52) U.S. Cl. CPC H04W 72/1278; H04W 72/14; H04L 5/0058
USPC 370/329

(57) ABSTRACT

Provided is a control channel scheduling method and an apparatus for performing the method in an orthogonal frequency division multiplexing access (OFDMA)-based wireless mesh network, the method including determining, by a grant node receiving a request for resources from a request node among a plurality of nodes included in the OFDMA-based wireless mesh network, whether another grant node is present in a preset range, performing, when the other grant node is present, a mesh election to acquire an authority to transmit a grant message, and transmitting, based on a result of the performing of the mesh election, information on an allowed transmission time for the grant message or a disallowed transmission time for the grant message to the request node.

### CROSS-REFERENCE TO RELATED APPLICATION

This application claims the priority benefit of Korean Patent Application No. 10-2013-0031558, filed on Mar. 25, 2013, in the Korean Intellectual Property Office, the disclosure of which is incorporated herein by reference.

### BACKGROUND

1. Field of the Invention The present invention relates to a control channel scheduling method and an apparatus for performing a control channel scheduling in an orthogonal frequency division multiplexing access (OFDMA)-based wireless mesh network.

2. Description of the Related Art

To support a mesh network, a time division multiple access (TDMA)-based mesh mode is included in an Institute of Electrical and Electronics Engineers (IEEE) 802.16 standard. Two scheduling schemes including a centralized scheduling and a distributed scheduling are defined in an IEEE 802.16 mesh mode. The centralized scheduling may be a management scheme for a base station (BS) node to schedule all nodes. The distributed scheduling may be a scheme in which each node performs a scheduling of a corresponding node without the BS node.

FIGS. 1A and 1B are diagrams illustrating a frame configuration for a distributed scheduling and three-way handshaking process in an Institute of Electrical and Electronics Engineers (IEEE) 802.16 mesh according to a related art.

Referring to FIG. 1A, a distributed scheduling (DSCH) may indicate a control slot for transmitting a distributed scheduling message, and a DATA may indicate a data slot for data transmission.

In a distributed scheduling of the IEEE 802.16 mesh, as described in FIG. 1A, each node may reserve resources of a neighboring node through the three-way handshaking process. For example, a request node including data to be transmitted may request a data slot to the neighboring node using a request message at a point in time of DSCH transmission of the request node. A grant node receiving a request for the resources from the request node may determine an area of the resources to be allocated to the request node, and transmit information associated with the determined area to the request node using a grant message at a point in time of DSCH transmission of the grant node. When the request node receives the grant message, the request node transmits a confirmation message to the grant node at a subsequent point in time of DSCH transmission of the request node, and completes a reservation of resources.

In the distributed scheduling of the IEEE 802.16, each node may use a mesh election algorithm to determine the point in time of DSCH transmission of the request node. The mesh election algorithm may be an algorithm for determining a point in time of DSCH transmission such that a predetermined node may transmit and receive a scheduling message without an occurrence of a collision with the neighboring node.

FIG. 2 is a flowchart illustrating a mesh election algorithm of an IEEE 802.16 mesh according to a related art.

In operations 210, 220, and 250, each node may generate a hash value for each DSCH transmission time using a unique node identifier (ID) and a DSCH number. In operation 230, each node may calculate the hash value of the node and hash values of competing nodes at a corresponding transmission time. In operation 240, when a result of comparing among the hash value of a corresponding node and the hash values of the competing nodes indicates that the hash value of the corresponding node is a maximum value, the corresponding node may win the mesh election and thus, acquire an authority to perform transmission in a corresponding DSCH. Here, the competing nodes may indicate all one-hop neighboring nodes and two-hop neighboring nodes participating in the mesh election at the corresponding DSCH transmission time.

However, in such a time division multiple access (TDMA)-based IEEE 802.16 mesh election algorithm, a scheduling delay time from a request to a confirm may be relatively long due to a competition with the two-hop neighboring nodes, as well as the one-hop neighboring nodes. Thus, application to a transmission of traffic susceptible to a time delay may be inappropriate.

Also, since each node may be partially aware of a transmission and reception situation of neighboring nodes in the distributed scheduling of the IEEE 802.16 mesh, the scheduling may be performed based on a portion of information associated with the transmission and reception situation. Due to this, each node may need to abandon resources to be allowed for another node among requested resources in order to prevent an occurrence of interference. However, a loss that may be attributed to the abandoning may affect an entire system.

Accordingly, there is a desire for a method that may reduce a scheduling time delay, avoiding a collision occurring between scheduling messages, and reducing, in data resources, an amount of interference occurring due to not acquiring scheduling information on a neighboring node.

### SUMMARY

An aspect of the present invention provides a control channel scheduling method and an apparatus for performing a control channel scheduling in an orthogonal frequency division multiplexing access (OFDMA)-based wireless mesh network to reduce a scheduling time delay.

Another aspect of the present invention also provides a control channel scheduling method and an apparatus for performing a control channel scheduling in an OFDMA-based wireless mesh network to avoid a collision occurring between scheduling messages.

Still another aspect of the present invention also provides a control channel scheduling method and an apparatus for performing a control channel scheduling in an OFDMA-based wireless mesh network to reduce an amount of interference occurring in data resources due to not acquiring scheduling information on a neighboring node.

According to an aspect of the present invention, there is provided a control channel scheduling method of an OFDMA-based wireless mesh network, the method including determining, by a grant node receiving a request for resources from a request node among a plurality of nodes included in the OFDMA-based wireless mesh network, whether another grant node is present in a preset range, performing, when the other grant node is present, a mesh election to acquire an authority to transmit a grant message, and transmitting, based on a result of the performing of the mesh election, information on an allowed transmission time for the grant message or a disallowed transmission time for the grant message to the request node.

The other grant node may be a grant node present in a one-hop distance from the grant node.

The other grant node may be a one-hop neighboring node that loses in a mesh election performed to acquire an authority to transmit a request message.

The request node may perform multiple requests to a plurality of grant nodes.

The performing may include generating a hash value using a control slot number for transmitting a distributed scheduling message and an identifier (ID) of the grant node, comparing the generated hash value and a hash value of the other grant node, and incorporating, when the generated hash value is a maximum value, a corresponding time in an allowed transmission time set for the grant message or removing the corresponding time from a disallowed transmission time set for the grant message.

The transmitting may include transmitting the information on the allowed transmission time for the grant message or the disallowed transmission time for the grant message along with information on a transmission time of a subsequent distributed scheduling message, subchannel information, and data scheduling information.

According to another aspect of the present invention, there is provided an apparatus for performing a control channel scheduling in an OFDMA-based wireless mesh network, the apparatus operating as a grant node, the apparatus including a determiner to determine whether another grant node is present in a preset range, when a request message is received from a request node among a plurality of nodes included in the OFDMA-based wireless mesh network, an acquirer to acquire an authority to transmit a grant message by performing a mesh election when the other grant node is present, and a transmitting and receiving unit to transmit, based on the acquired authority, information on an allowed transmission time for the grant message or a disallowed transmission time for the grant message to the request node.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIGS. 1A and 1B are diagrams illustrating a frame configuration for a distributed scheduling and three-way handshaking process in an Institute of Electrical and Electronics Engineers (IEEE) 802.16 mesh according to a related art;

FIG. 2 is a flowchart illustrating a mesh election algorithm of an IEEE 802.16 mesh according to a related art;

FIG. 3 is a diagram illustrating a frame configuration of an orthogonal frequency division multiplexing access (OFDMA)-based wireless mesh network according to a related art;

FIG. 4 is a flowchart illustrating an OFDMA-based mesh election algorithm according to a related art;

FIGS. 5A and 5B are diagrams illustrating a difference between an OFDMA-based distributed scheduling and a time division multiple access (TDMA)-based distributed scheduling according to a related art;

FIGS. 6A and 6B are diagrams illustrating a case in which a collision occurs between grant messages in an OFDMA-based distributed scheduling according to a related art;

FIG. 7 is a flowchart illustrating an OFDMA-based mesh election algorithm according to an embodiment of the present invention;

FIG. 8 is a diagram illustrating an example of a control channel scheduling method of an OFDMA-based wireless mesh network according to an embodiment of the present invention; and

FIG. 9 is a block diagram illustrating a control channel scheduling apparatus for an OFDMA-based wireless mesh network according to an embodiment of the present invention.

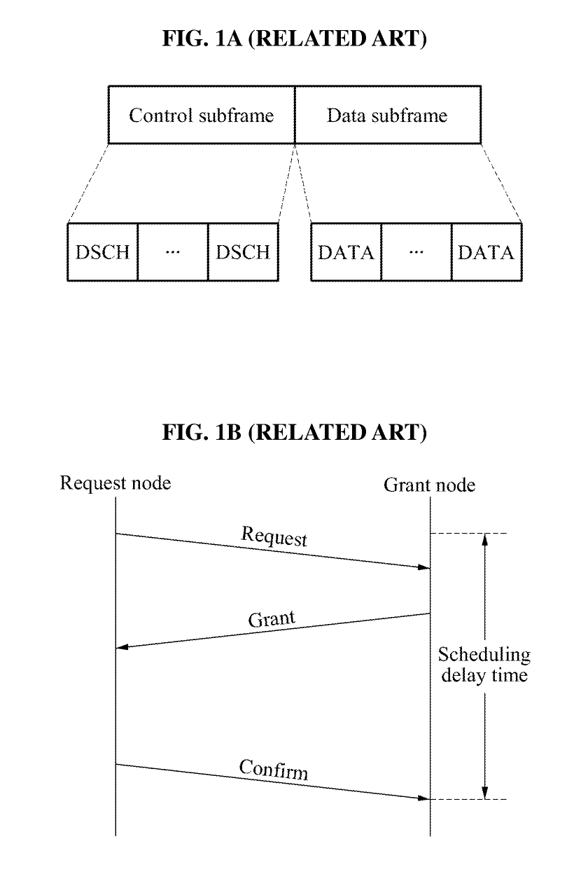

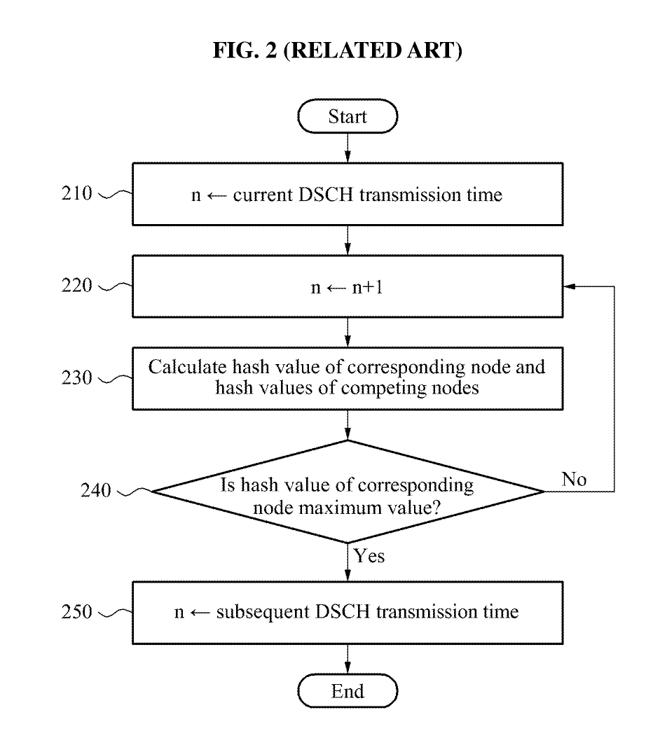

### DETAILED DESCRIPTION

Hereinafter, embodiments will be described in detail with reference to the accompanying drawings.

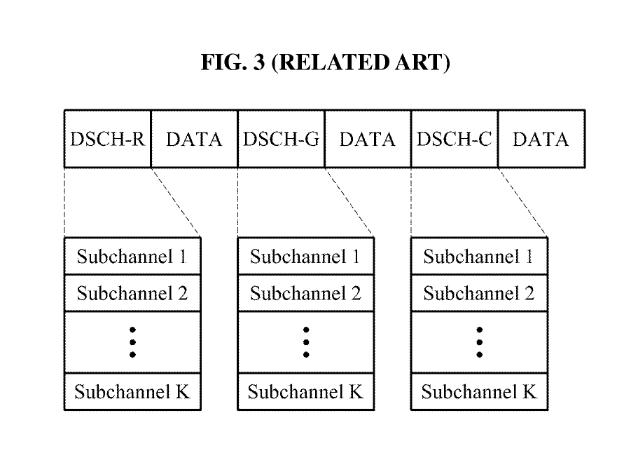

FIG. 3 is a diagram illustrating a frame configuration of an orthogonal frequency division multiplexing access (OFDMA)-based wireless mesh network according to a related art.

Referring to FIG. 3, a distributed scheduling (DSCH) may indicate a subframe for transmitting a distributed scheduling message, and a DATA may indicate a subframe for data transmission. Also, a DSCH-R, a DSCH-G, and a DSCH-C may indicate a DSCH for request, a DSCH for grant, and a DSCH for confirmation, respectively.

In the frame configuration of the OFDMA-based wireless mesh network, a time slot of an existing time division multiple access (TDMA) scheme may be divided into a number of, for example, K subchannels and thus, a delay time between scheduling messages may be reduced. Here, K indicates a natural number.

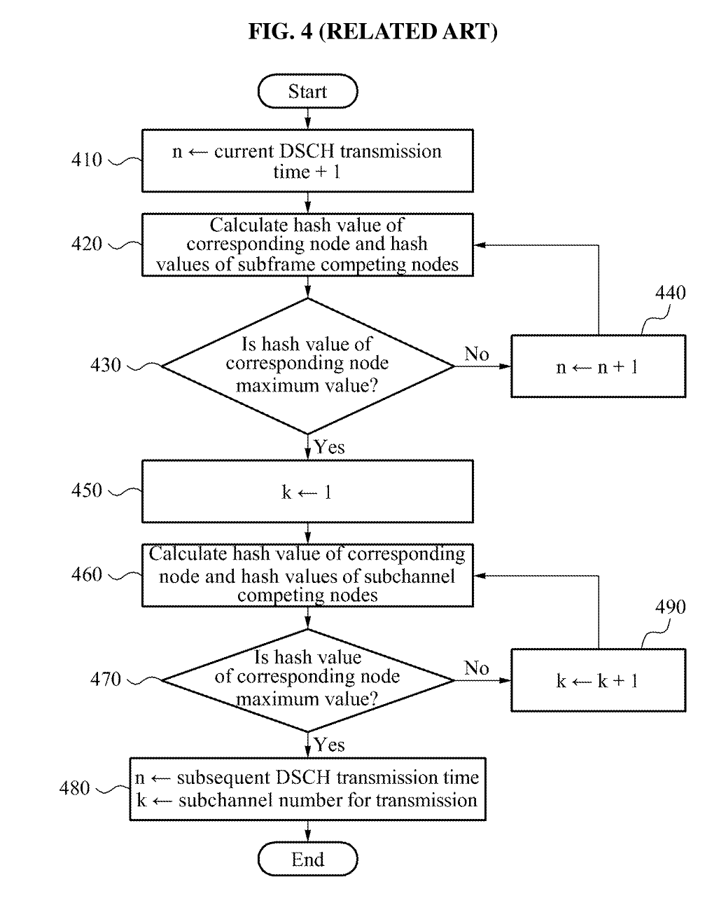

FIG. 4 is a flowchart illustrating an OFDMA-based mesh election algorithm according to a related art.

In operation 410, each node included in the OFDMA-based wireless mesh network may generate a hash value at a current DSCH transmission time using a unique node identifier (ID) and a DSCH number, and in operation 420, may calculate the generated hash value and hash value of subframe competing nodes. Here, the subframe competing node may indicate all one-hop neighboring nodes participating in a mesh election for a corresponding subframe at a corresponding DSCH transmission time.

In operation 430, each node may compare the hash value of the corresponding node and the hash value of the subframe competing nodes. When the hash value of the corresponding node is a maximum value, that is, when the corresponding node wins a competition with the one-hop neighboring nodes with respect to the corresponding subframe, the corresponding node may perform a competition with two-hop neighboring nodes that win a competition for a corresponding subframe in operations 450 through 470. However, when the corresponding node does not win the competition with the one-hop neighboring nodes with respect to the corresponding subframe, the corresponding node may generate a hash value again at a subsequent DSCH transmission time in operation 440. Through this, the corresponding node may perform a competition with subframe competing nodes to acquire an authority for transmitting a scheduling message.

For example, in operation 460, the node that wins the competition with the one-hop neighboring nodes with respect to the corresponding subframe may calculate the hash value of the corresponding node and hash values of subchannel competing nodes to acquire an authority for transmitting a scheduling message using a subchannel of the corresponding subframe. Here, the subchannel competing nodes may indicate two-hop neighboring nodes that win a competition for a corresponding subframe at a corresponding DSCH transmission time.

In operation 470, the node may compare the hash value of the node and the hash values of the subchannel competing nodes, and when the hash value of the node is determined to be a maximum value, that is, when the node wins the competition for the subframe and the competition for the subchannel, the node may acquire the authority for transmitting the scheduling message using a subchannel k of the corresponding subframe in operation 480.

In operation 490, when the node does not win a competition with subchannel competing nodes with respect to the subchannel k, the node may perform a competition for a subsequent subchannel k+1.

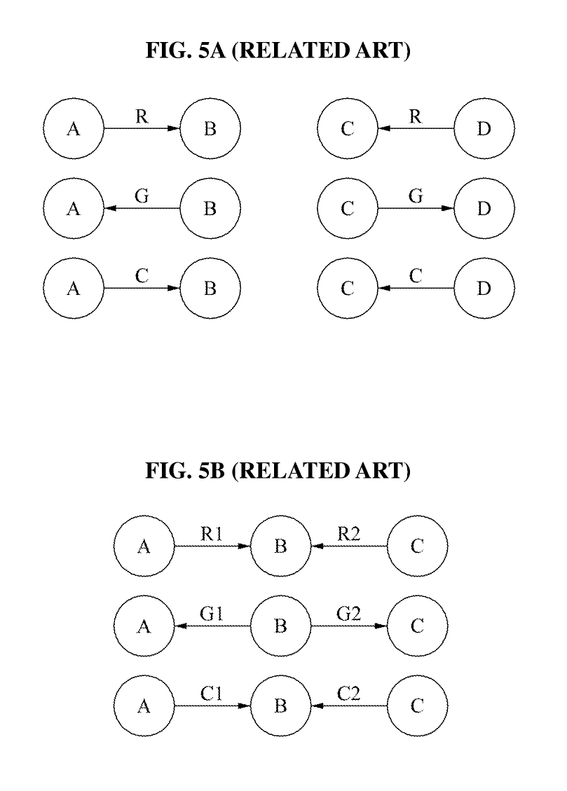

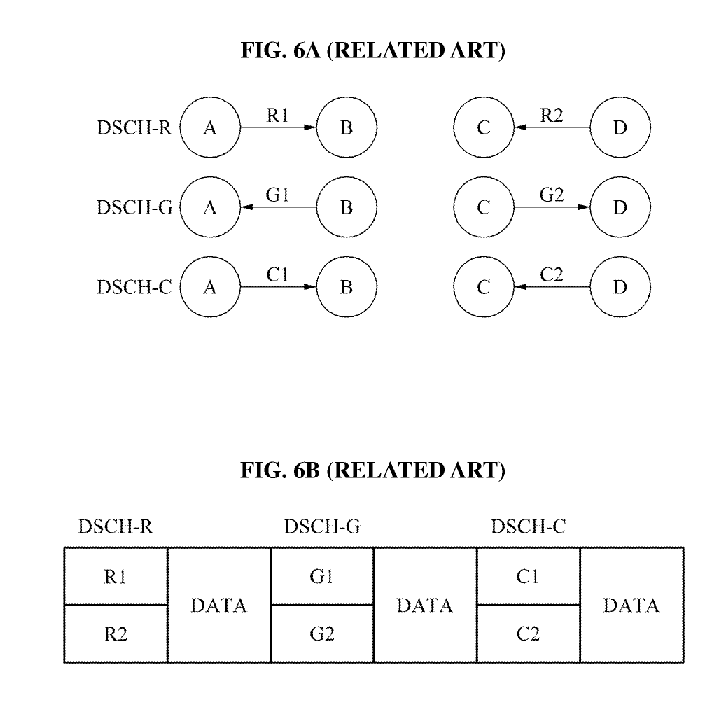

FIGS. 5A and 5B are diagrams illustrating a difference between an OFDMA-based distributed scheduling and a TDMA-based distributed scheduling according to a related art. FIGS. 6A and 6B are diagrams illustrating a case in which a collision occurs between grant messages in an OFDMA-based distributed scheduling according to a related art.

Referring to 5A and 5B, each of A, B, C, and D may indicate a node, R may indicate a request message, G may indicate a grant message, and C may indicate a confirmation message.

In the TDMA scheme, to transmit and receive a scheduling message in a control slot, without an occurrence of a collision, a distance between the request nodes, for example, a node A and a node D may need to be at least a two-hop distance as described in FIG. 5A. However, in an OFDMA scheme, since a different subchannel is used, the scheduling message may be transmitted and received without an occurrence of a collision although in a case in which the distance between the request nodes, for example, the node A and a node C is a one-hop distance as described in FIG. 5B. For example, referring to FIG. 5B, the node A and the node C may transmit a request message R1 and a request message R2 using a subchannel 1 and a subchannel 2, and a node B receiving all of the request message R1 and the request message R2 may transmit, to the node A and the node C, a grant message G1 and a grant message G2 using the subchannel 1 and the subchannel 2. However, in the OFDMA scheme, when a distance between the request nodes is the two-hop distance, a collision may occur between the grant messages.

Hereinafter, descriptions about a case in which a collision between the grant messages will be provided with reference to FIGS. 6A and 6B. For convenience and ease of description, it is assumed that four nodes including a node A, a node B, a node C, and a node D may be disposed in a row, and a DSCH may include two subchannels in FIG. 6A and 6B.

When the node A and the node D transmit request messages to the node B and the node C using a DSCH-R of each of the two subchannels, the node B and the node C receiving the request messages may transmit grant messages using a DSCH-G of each corresponding sun-channel. However, since the node B and the node C are in a one-hop neighboring relationship, the node B and the node C may not receive grant messages from one another and thus, may not acquire scheduling information from one another. Thus, a distributed scheduling described below may be performed to prevent an occurrence of a collision between the grant messages using a control channel scheduling method of the OFDMA-based wireless mesh network according to an example embodiment.

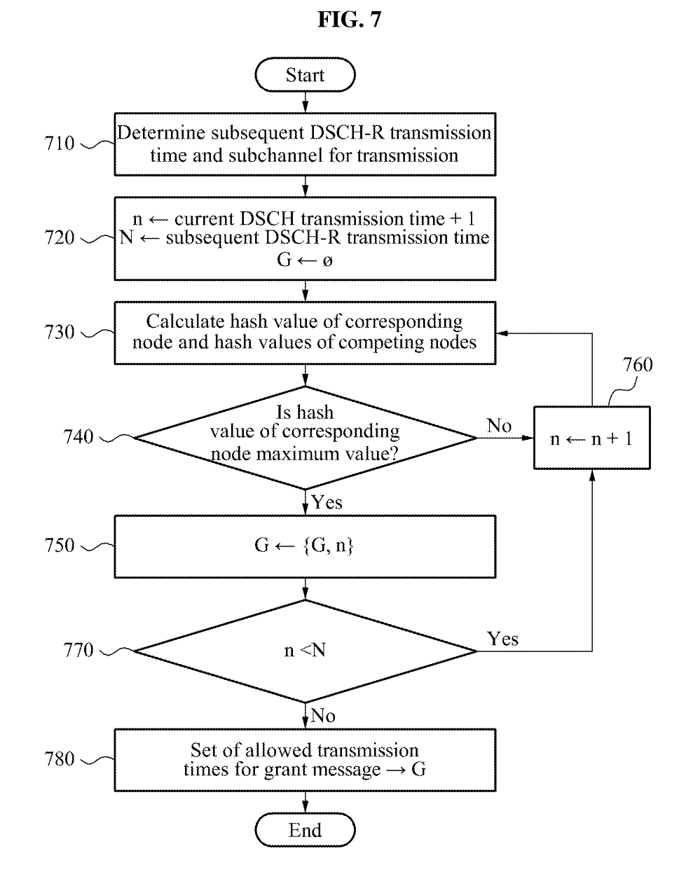

FIG. 7 is a flowchart illustrating an OFDMA-based mesh election algorithm according to an embodiment of the present invention. Hereinafter, descriptions about a control channel scheduling method of an OFDMA-based wireless mesh network will be provided with reference to FIG. 7.

In an existing OFDMA-based distributed scheduling method, a grant node receiving a request for data resources from a request node may acquire an authority for transmitting a grant message using a DSCH-G. However, in the control channel scheduling method of an OFDMA-based wireless mesh network, when another grant node is present in a one-hop distance of the grant node receiving the request for data resources from the request node, the grant node may acquire the authority for transmitting the grant message using the DSCH-G only in a case in which the grant node wins a competition through a mesh election. In this example, a process in which each node determines a subsequent DSCH-R transmission time and a subchannel for transmission may be identical to the algorithm of FIG. 4.

When the subsequent DSCH-R transmission time and the subchannel for transmission is determined, in the existing OFDMA-based distributed scheduling method, the grant node may transmit information on the subsequent DSCH transmission time and subchannel information along with data scheduling information at a current distributed scheduling message transmission time. However, in the OFDMA-based distributed scheduling method according to an example embodiment, to prevent the request node from sending a request to a node lacking the authority to transmit the DSCH-G, information associated with a grant message transmission allowing or disallowing time set G may be transmitted to the request node using the DSCH-G, along with the information on the subsequent DSCH transmission time, the subchannel information, and the data scheduling information. Thus, the request node receiving the information may perform a request only to a node having the authority for transmitting a grant message.

Hereinafter, descriptions about an example of a process in which a grant node transmits information of a grant message transmission allowing time set to a request node will be provided with reference to FIG. 7.

When a subsequent DSCH-R transmission time and a subchannel for transmission is determined through the process of FIG. 4 in operations 710 and 720, the grant node may calculate a hash value of the grant node and hash values of grant competing nodes in operation 730. Here, the grant competing nodes may indicate all one-hop neighboring nodes that lose in a mesh election of a DSCH-R in a corresponding DSCH.

In operation 740, the grant node may compare the hash value of the grant node and the hash values of the grant competing nodes. When the hash value of the grant node is a maximum value, the grant node may incorporate the corresponding DSCH transmission time in the grant message transmission allowing time set in operation 750. When the hash value of the grant node is not a maximum value, the grant node may increase a current DSCH transmission time by “1” in operation 760, and repeat a process of comparing the hash value of the grant node and the hash value of the grant competing nodes.

By repeating the process until the current DSCH transmission time is greater than a subsequent DSCH-R transmission time in operation 770, the grant node may transmit, to the request node, information associated with all grant message transmission allowing time set between the current DSCH-R transmission time and the subsequent DSCH-R transmission time in operation 780.

As used herein, a transmission time may indicate a predetermined time interval or a predetermined time period. Also, the transmission time may indicate a predetermined point in time.

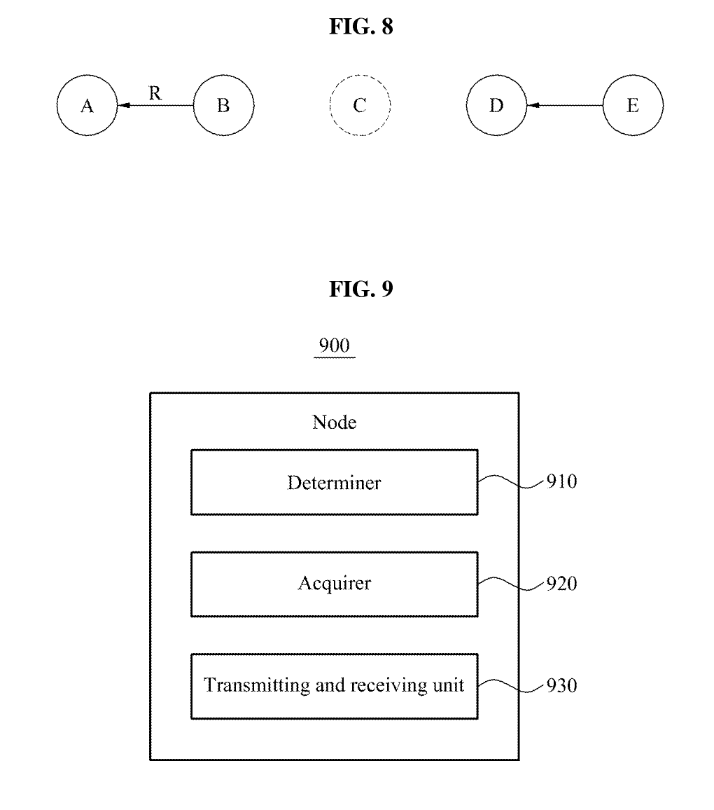

FIG. 8 is a diagram illustrating an example of a control channel scheduling method of an OFDMA-based wireless mesh network according to an embodiment of the present invention.

Referring to FIG. 8, each of a node B and a node E may be a request node acquiring an authority for transmitting a DSCH-R, each of a node A and a node D may be a node having an authority for transmitting a DSCH-G, and a node S may be a node lacking the authority to transmit the DSCH-G.

In this example, the node B may request to the node A or the node C while the node C may request only to the node A because the node C does not have the authority for transmitting the DSCH-G. The node E may request to the node D having the authority for transmitting the DSCH-G.

As described above, since sending a request from the request node to a node lacking the authority to transmit the DSCH-G may be prevented, an occurrence of a collision between the grant messages of the node C and the node D may also be prevented.

FIG. 9 is a block diagram illustrating a control channel scheduling apparatus for an OFDMA-based wireless mesh network according to an embodiment of the present invention.

The control channel scheduling apparatus for the OFDMA-based wireless mesh network according to an example embodiment may be one of nodes included in the OFDMA-based wireless mesh network.

A node 900 included in the OFDMA-based wireless mesh network may be a grant node to perform a control channel scheduling in a process of an operation. To this end, the node 900 may include a determiner 910, an acquirer 920 and a transmitting and receiving unit 930 as illustrated in FIG. 9.

When a request message is received from a request node among a plurality of nodes included in the OFDMA-based wireless mesh network, the determiner may determine whether another grant node is present in a preset range. Here, the other grant node may be a grant node present in a one-hop distance from the node 900. For example, the other grant node may be a one-hop neighboring node that loses in a mesh election for acquiring an authority for transmitting a request message. The request node may perform multiple requests to a plurality of grant nodes.

When the determiner 910 determines that the other grant node is present, the acquirer 920 may participate in the mesh election and acquire the authority for transmitting a grant message. To this end, the acquirer may generate a hash value using a control slot number for transmitting a distributed scheduling message and an ID of the grant ID. Also, the acquirer 920 may calculate the generated hash value and the hash value of the other grant node to compare the calculated hash values. In this example, when the generated hash value is a maximum value, the corresponding time may be incorporated in a grant message transmission allowing time set or removed from a grant message transmission disallowing time.

The transmitting and receiving unit 930 may transmit, to the request node, information on an allowed transmission time for the grant message or information on a disallowed transmission time for the grant message based on the authority for transmitting the grant message acquired by the acquirer 920. In this example, the transmitting and receiving unit 930 may transmit, to the request node, the information on the allowed transmission time for the grant message or the information on the disallowed transmission time for the grant message, along with information on a subsequent transmission time for a distributed scheduling message, subchannel information, and data scheduling information.

According to an aspect of the present invention, it is possible to reduce a delay time between scheduling messages by dividing a time slot of a frame configuration based on a time division multiple access (TDMA) scheme, into a number of subchannels on a frequency.

According to another aspect of the present invention, by determining another grant message is present within a preset range when a grant node receives a request for resources from a request node, performing a mesh election to acquire an authority for transmitting a grant message, and transmitting information associated with an allowed transmission time for the grant message or a disallowed transmission time for the grant message to the request node, it is possible to avoid a collision that may occur between scheduling messages in an existing orthogonal frequency division multiplexing access (OFDMA)-based distributed scheduling scheme and thus, enhance a level of reliability of scheduling information.

According to still another aspect of the present invention, it is possible to improve a quality of a signal in a mesh network by preventing a node not having an authority for transmitting a grant message from receiving a request, and reducing an amount of interference occurring in data resources due to not acquiring scheduling information on a neighboring node.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, other implementations, alternative embodiments and equivalents to the claimed subject matter are construed as being within the appended claims.

What is claimed is:

1. A control channel scheduling method of an orthogonal frequency division multiplexing access (OFDMA)-based wireless mesh network, the method comprising:
determining, by a grant node receiving a request for resources from a request node among a plurality of nodes included in the OFDMA-based wireless mesh network, whether another grant node is present in a preset range;
performing, when the other grant node is present, a mesh election to acquire an authority to transmit a grant message; and
transmitting, based on a result of the mesh election, information on an allowed transmission time for the grant message or a disallowed transmission time for the grant message to the request node.

2. The method of claim 1, wherein the other grant node is a grant node present in a one-hop distance from the grant node.

3. The method of claim 1, wherein the other grant node is a one-hop neighboring node that loses in a mesh election performed to acquire an authority to transmit a request message.

4. The method of claim 1, wherein the request node performs multiple requests to a plurality of grant nodes.

5. The method of claim 1, wherein the performing comprises generating a hash value using a control slot number for transmitting a distributed scheduling message and an identifier (ID) of the grant node,
comparing the generated hash value and a hash value of the other grant node, and
incorporating, when the generated hash value is a maximum value, a corresponding time in an allowed transmission time set for the grant message or removing the corresponding time from a disallowed transmission time set for the grant message.

6. The method of claim 1, wherein the transmitting comprises transmitting the information on the allowed transmission time for the grant message or the disallowed transmission time for the grant message along with information on a transmission time of a subsequent distributed scheduling message, subchannel information, and data scheduling information.

7. An apparatus for performing a control channel scheduling in an orthogonal frequency division multiplexing access (OFDMA)-based wireless mesh network, the apparatus operating as a grant node, the apparatus comprising:
a determiner to determine whether another grant node is present in a preset range, when a request message is received from a request node among a plurality of nodes included in the OFDMA-based wireless mesh network;
an acquirer to acquire an authority to transmit a grant message by performing a mesh election when the other grant node is present; and
a transmitting and receiving unit to transmit, based on the acquired authority, information on an allowed transmission time for the grant message or a disallowed transmission time for the grant message to the request node.

8. The apparatus of claim 7, wherein the other grant node is a grant node present in a one-hop distance from the grant node.

9. The apparatus of claim 7, wherein the other grant node is a one-hop neighboring node that loses in a mesh election performed to acquire an authority to transmit a request message.

10. The apparatus of claim 7, wherein the request node performs multiple requests to a plurality of grant nodes.

11. The apparatus of claim 7, wherein the acquirer generates a hash value using a control slot number for transmitting a distributed scheduling message and an identifier (ID) of the grant node, compares the generated hash value and a hash value of the other grant node, and when the generated hash value is a maximum value, incorporates a corresponding time in an allowed transmission time set for the grant message or removes the corresponding time from a disallowed transmission time set for the grant message.

12. The apparatus of claim 7, wherein the transmitting and receiving unit transmits, to the request node, the information on the allowed transmission time for the grant message or the disallowed transmission time for the grant message along with information on a transmission time of a subsequent distributed scheduling message, subchannel information, and data scheduling information.
